(19) United States
(12) Patent Application Publication
(10) Pub. No.: US 2015/0198219 A1
(43) Pub. Date: Jul. 16, 2015

(54) CENTRIFUGAL PENDULUM DEVICE

(71) Applicant: Schaeffler Technologies GmbH & Co. KG, Herzogenaurach (DE)

(72) Inventor: Christian Huegel, Rheinau (DE)

(21) Appl. No.: 14/420,337

(22) PCT Filed: Aug. 1, 2013
(86) PCT No.: PCT/DE2013/200091

§ 371 Date: Feb. 6, 2015

(30) Foreign Application Priority Data
Aug. 10, 2012 (DE) 10 2012 214 320.3

(51) Int. Cl. F16F 15/14

(52) U.S. Cl. CPC F16F 15/145

(57) ABSTRACT

A centrifugal pendulum device having a pendulum flange and a pendulum mass, wherein the pendulum mass is pivotable in a limited manner along a pendulum path with respect to the pendulum flange via at least two running rollers which are able to roll and are received in at least one guide track in the pendulum mass and in at least one guide track in the pendulum flange, wherein the movement of the pendulum mass can be limited by abutment against the pendulum flange and wherein an annular damper for damping the abutment is arranged on a component that is able to come into abutment against the pendulum flange. In this case, the cross-sectional area of the damper takes up less than 87 percent of a surrounding rectangular area.

The present invention relates to a centrifugal pendulum device having the features according to the definition of the species in claim 1.

These types of centrifugal pendulum devices are known, in their mode of operation as rotational speed-adaptive torsional vibration dampers, in particular from use in motor vehicle drive trains, from DE 10 2011 013 232 A1. Here, pendulum masses are arranged to pivot in a limited manner on a pendulum flange, which is driven by a drive unit affected by torsional vibration, such as an internal combustion engine. As a result of the pendulum movement of the pendulum masses relative to the pendulum flange, caused by a different rotational acceleration of the pendulum flange, a damping effect occurs on the torsional vibrations.

For example, the pendulum flange may be integrally formed as a component of a torsional vibration damper or a dual-mass flywheel, or be situated on one of these components. Pendulum masses may be situated on both sides of the pendulum flange, axially opposite pendulum masses being connected with the aid of spacer bolts. In this case, the spacer bolts move in cut-outs, which are adapted in their shape to the pendulum movement of the pendulum masses. The pendulum masses are guided on the pendulum flange with the aid of guide tracks incorporated in them, for example in the form of arc-shaped through-holes, which are complementary to guide tracks formed in the pendulum flange, whereby rolling elements roll in the guide tracks. The pendulum masses may pivot in a limited manner relative to the pendulum flange, the spacer bolts being able to strike the guide track in the pendulum flange. For this purpose, an annular damping means, which may dampen the impact, is mounted on the spacer bolt.

The object of the present invention is to improve the reliability of the damping means and the efficiency of the damping.

According to the present invention, this object is achieved by a centrifugal pendulum device having the features of claim 1.

Accordingly, a centrifugal pendulum device including a pendulum flange and a pendulum mass is provided, the pendulum mass being able to pivot in a limited manner along a pendulum path relative to the pendulum flange with the aid of at least two rollers that are accommodated and may roll in at least one guide track in the pendulum mass and in at least one guide track in the pendulum flange, the movement of the pendulum mass being able to be limited via an impact on the pendulum flange, and an annular damping means for damping of the impact is situated on a component that may strike the pendulum flange. In this way, the cross-sectional area of the damping means takes up less than 87 percent of a surrounding rectangular area.

The surrounding rectangular area is understood to be the surface of a rectangle that is spanned by the maximum radial height and the maximum axial width of the cross-sectional area of the annular damping means.

The component that may strike the pendulum flange is preferably formed by a spacer bolt and/or a roller. In particular, the component may strike a cut-out or a guide track in the pendulum flange.

In one particularly advantageous specific embodiment of the present invention, the cross-sectional area has a radial height, and the cross-sectional area assigned to the outer half of the radial height takes up less than 80 percent of this half radial height corresponding to the surrounding rectangular area. This surrounding rectangular area is thus spanned by half of the maximum radial height and the maximum axial width.

In one further embodiment of the present invention, the cross-sectional area assigned to the inner half of the radial height takes up less than 96 percent of this half radial height corresponding to the surrounding rectangular area. This rectangular area is defined as described above.

In one preferred specific embodiment of the present invention, the damping means surrounds a spacer bolt and/or a roller.

In one further specific embodiment of the present invention, the damping means is formed as an elastic means, in particular as an elastomer, or thermoplastic material or a plastic.

In one further specific embodiment of the present invention, the damping means is formed as a composite element made up of at least a first and a second subcomponent.

In one further specific embodiment of the present invention, the damping means is affixed in an integrally bonded and/or form-locked and/or force-fit manner to a component that may strike the pendulum flange.

In one further specific embodiment of the present invention, the damping means is formed in one piece with a component that may strike the pendulum flange.

In one further specific embodiment of the present invention, the damping means has a flattened section at at least one radial end area.

Other advantages and advantageous embodiments of the present invention result from the description and the drawings, and their true-to-scale reproduction has been omitted for the sake of clarity. All aforementioned features are applicable not only in the combinations provided, but also in other combinations or alone, without departing from the scope of the present invention.

The present invention is described in greater detail below with reference to the drawings.

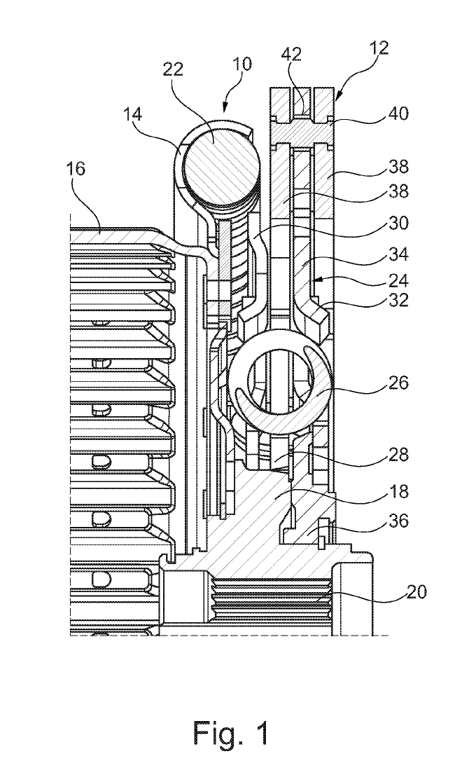

FIG. 1 shows a side view of a torsional vibration damper including a centrifugal pendulum device in a specific embodiment of the present invention.

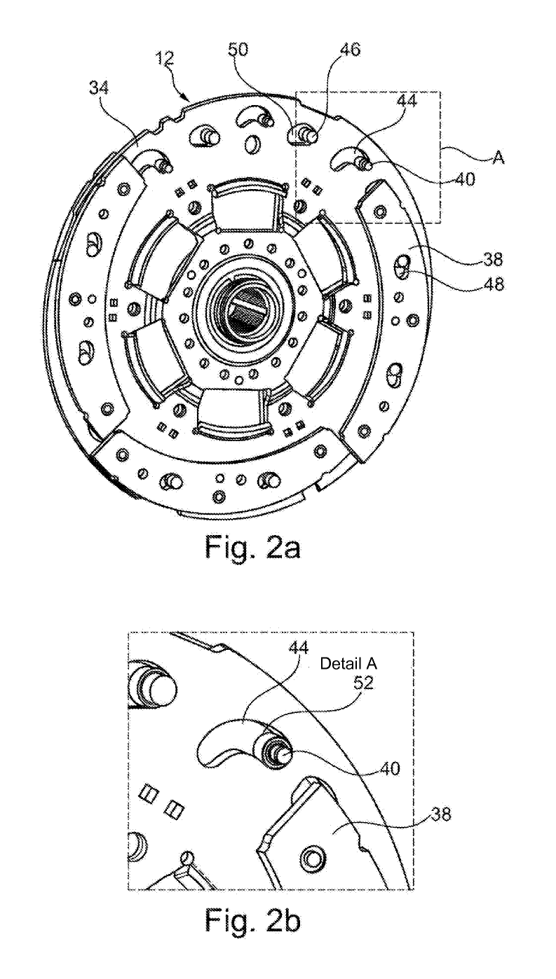

FIG. 2a shows a side view of the torsional vibration damper in a specific embodiment of the present invention.

FIG. 2b shows a detailed spatial view of detail A from FIG. 2a.

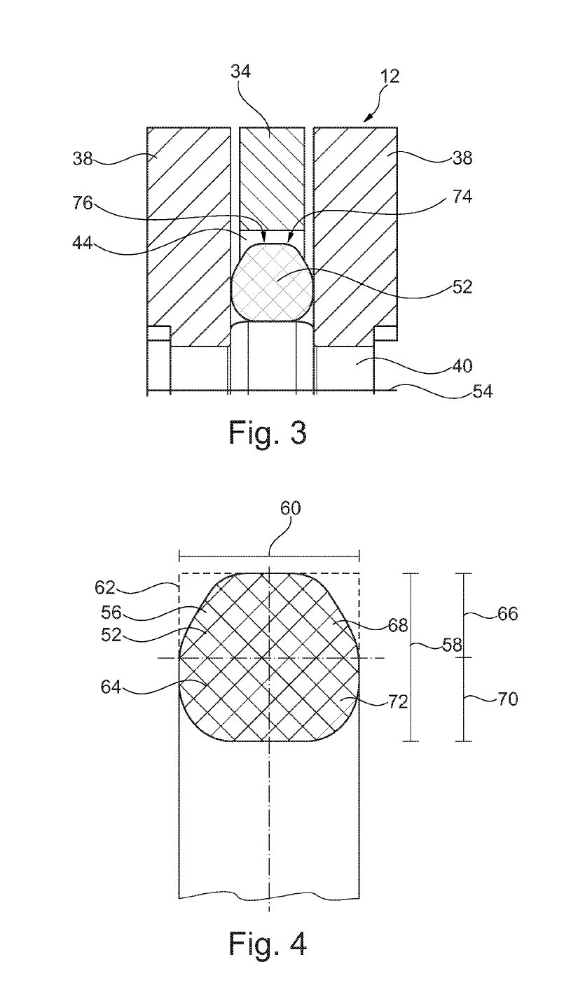

FIG. 3 shows a cross-sectional detail of a centrifugal pendulum device in a specific embodiment of the present invention.

FIG. 4 shows a cross section of the damping means from FIG. 3.

FIG. 1 shows a side view of a torsional vibration damper 10 including a centrifugal pendulum device 12. A disk carrier 16, functioning as a clutch output of a clutch device, is situated on damper input member 14 of torsional vibration damper 10, designed as a series damper. The clutch device may be designed as a converter lockup clutch or as a wet clutch. Torsional vibration damper 10 is situated operatively between the clutch output and an output hub 18, output hub 18 being connectable via gear teeth 20 to a transmission input shaft of a transmission in a motor vehicle drive train.

Damper input member 14 is radially centered internally on output hub 18 and held in an axially secured manner, and radially encompasses externally first energy storage elements 22, such as bow springs, which operatively connect damper input member 14 to an intermediate damper member 24, intermediate damper member 24 being rotatable in a limited manner relative to damper input member 14. Intermediate damper member 24 in turn is rotatable in a limited manner relative to a damping output member 28, via the effect of second energy storage elements 26, such as pressure springs, that are radially more toward the center. Damper output member 28 is rotatably fixedly connected to output hub 18, for example via a welded joint.

Intermediate damper member 24 is composed of two axially spaced disk members 30, 32, which axially enclose damper output member 28. One disk member 32 is then extended outward to form a pendulum flange 34. Pendulum flange 34 is an integral part of disk member 32, but it may also be attached as a separate component thereto, for example by riveting, bolting or welding. Disk member 32 is rotatably fixedly connected radially internally to a turbine hub 36, and turbine hub 36 is used as the connection for a turbine wheel of a hydrodynamic torque converter. Turbine hub 36 is centered on output hub 18 and situated rotatably fixedly thereto.

Pendulum flange 34 accommodates, in a radially outward section, two axially opposing pendulum masses 38, pendulum masses 38 being connected to each other via a spacer bolt 40, and spacer bolt 40 penetrates a cutout 42 in pendulum flange 34.

FIG. 2a shows a side view of the centrifugal pendulum device 12 in a specific embodiment of the present invention, where the upper pendulum mass has been omitted from the drawing to illustrate the underlying area. Centrifugal pendulum device 12 is situated on disk member 32 of the intermediate damper member of the torsional vibration damper, the radial extension of disk member 32 forming pendulum flange 34 for accommodating pendulum masses 38 situated on both sides of pendulum flange 34, each two pendulum masses 38 being axially situated on both sides of pendulum flange 34 and connected to each other via spacer bolts 40 to form a pendulum mass pair.

Spacer bolts 40 extend through cutouts 44 in pendulum flange 34, cutouts 44 being formed as arcs, in such a way that these allow a pendulum motion of pendulum masses 38 along a pendulum path relative to pendulum flange 34. Pendulum masses 38 are guided by rollers 46 on pendulum flange 34, where rollers 46 may roll in arc-shaped guide tracks 48 in pendulum masses 38 and in complementary arc-shaped guide tracks 50 in pendulum flange 34.

The movement of pendulum masses 38 relative to pendulum flange 34 may be limited by the impact of spacer bolts 40 on the respective cutouts 44. FIG. 2b shows a detail A from FIG. 2a in a spatial representation. Spacer bolts 40 here have an annular damping means 52, in particular on its rolling surface, whereby an impact of spacer bolts 40 on cutouts 44 may be dampened.

FIG. 3 shows a cross-sectional detail of a centrifugal pendulum device 12 in a specific embodiment of the present invention. Pendulum masses 38 situated on both sides of pendulum flange 34 are connected to each other by a spacer bolt 40, which reaches through and moves within a cutout 44 in pendulum flange 34 in order to make this connection and to facilitate the pendulum path. Here an impact of spacer bolt 40 on cutout 44 of pendulum flange 34 is possible. The impact may be dampened by a damping means 52 surrounding spacer bolt 40. In this drawing only the radial upper half of the cross section with respect to a center axis 54 of spacer bolt 40 is illustrated.

Here, damping means 52 has a flattened area 76 at a radial end area 74, in this case a radially outer end area, whereby a better contact may be achieved on cutout 44 during impact. Another flattened area is also formed on the radially inner end area, whereby a better connection of damping means 52 to spacer bolt 44 may be possible.

FIG. 4 shows a radial upper cross section of annular damping means 52 from FIG. 3. Here, cross section 56 has a maximum radial height 58 and a maximum axial width 60. These parameters span a rectangle 62 surrounding cross section 56. It has been shown that the reliability of damping means 52 may be increased when the cross-sectional area 64 of damping means 52 takes up less than 87 percent of the surrounding surface area of rectangle 62.

Preferably, the damping means' outer radial cross-sectional area 68, assigned to the half radial height 66, takes up less than 80 percent of this half radial height corresponding to the surrounding rectangular area. Furthermore, or alternatively, it is particularly advantageous if the radially inner cross-sectional area 72 of damping means 52, assigned to the half radial height 70, takes up less than 96 percent of the rectangular area spanned by this half radial height 70 and axial width 60.

### LIST OF REFERENCE NUMERALS

10 torsional vibration damper
12 centrifugal pendulum device
14 damper input member
16 disk carrier
18 output hub
20 gear teeth
22 energy storage element
24 intermediate damper member
26 energy storage element
28 damper output member
30 disk member
32 disk member
34 pendulum flange
36 turbine hub
38 pendulum mass
40 spacer bolt
42 cutout
44 cutout
46 roller
48 guide track
50 guide track
52 damping means
54 center axis
56 cross-section
58 height
60 width
62 rectangle
64 cross-sectional area
66 height
68 cross-sectional area
70 height
72 cross-sectional area

What is claimed is:

1-9. (canceled)

10. A centrifugal pendulum device comprising:
a pendulum flange; and
a pendulum mass, the pendulum mass being pivotable in a limited manner along a pendulum path relative to the pendulum flange with the aid of at least two rollers accommodated and rollable in at least one guide track in the pendulum mass and in at least one guide track in the pendulum flange, movement of the pendulum mass limitable by an impact on the pendulum flange, and an annular damper for damping of the impact being situated on a component capable of striking the pendulum flange, the cross-sectional area of the damper takes up less than 87 percent of a surrounding rectangular area.

11. The centrifugal pendulum device as recited in claim 10 wherein the cross-sectional area has a radial height and the cross-sectional area assigned to an outer half radial height takes up less than 80 percent of the rectangular area corresponding to the outer half radial height.

12. The centrifugal pendulum device as recited in claim 10 wherein the cross-sectional area has a radial height and the cross-sectional area assigned to an inner half radial height takes up less than 96 percent of the rectangular area corresponding to the inner half radial height.

13. The centrifugal pendulum device as recited in claim 10 wherein the damper surrounds the component, the component being a spacer bolt or a roller.

14. The centrifugal pendulum device as recited in claim 10 wherein the damper is elastic.

15. The centrifugal pendulum device as recited in claim 14 wherein the damper is an elastomer or a thermoplastic material or a plastic.

16. The centrifugal pendulum device as recited in claim 10 wherein the damper is formed as a composite element made up of at least a first and a second subcomponent.

17. The centrifugal pendulum device as recited in claim 10 wherein the damper is affixed in an integrally bonded or form-locked or force-fit manner to the component.

18. The centrifugal pendulum device as recited in claim 10 wherein the damper is formed in one piece with the component.

19. The centrifugal pendulum device as recited in claim 10 wherein the damper has a flattened section at at least one radial end area.
